(19) United States
(12) Patent Application Publication
(10) Pub. No.: US 2012/0271601 A1
(43) Pub. Date: Oct. 25, 2012

(54) SYSTEMS AND METHODS FOR FORECASTING PROCESS EVENT DATES

(75) Inventors: Ali Afsin Bulbul, Beaverton, OR (US); Guillaume F. De Bergh, Portland, OR (US); Chitra Dorai, Chappaqua, NY (US); Nan Shao, Elmsford, NY (US); Alejandro Veen, New York, NY (US); Zakary B. Washburn, Vancouver, WA (US)

(73) Assignee: International Business Machines Corporation, Armonk, NY (US)

(21) Appl. No.: 13/112,687

(22) Filed: May 20, 2011

Related U.S. Application Data
(60) Provisional application No. 61/476,950, filed on Apr. 19, 2011.

(51) Int. Cl. G06F 7/60

(52) U.S. Cl. 703/2

(57) ABSTRACT

Systems and methods are provided for forecasting event dates. In one method, one or more defined process events are identified. For one event, a duration distribution between two dates is estimated dynamically. The first date may be the start date of the event and the second date may be the end date of the last event in the process. The estimated duration distribution is used for generating one or more modeling parameters used for forecasting.

### BACKGROUND

This application claims benefit to U.S. Provisional patent application No. 61/476,950, filed Apr. 19, 2011, the entire contents and disclosure of each of which is expressly incorporated by reference herein as if fully set forth herein.

This invention relates to event forecasting using computerized systems and methods.

Many processes involve a number of events that occur over time. For example, the process of applying for a driver's license may involve the following eight events:
(1) applicant schedules the written test with the department of motor vehicles;
(2) applicant takes/submits written test to department of motor vehicles;
(3) department of motor vehicles reviews the written test and informs failed applicant to take written test again or successful applicant to take road test;
(4) applicant schedules the road test;
(5) applicant takes the road test;
(6) department of motor vehicles reviews results of road test and informs failed applicant to take road test again or successful applicant that driver's license will be issued;
(7) department of motor vehicles prints driver's license for applicant;
(8) driver's license is mailed to applicant.

Each event in the process typically has an associated start date and end date. As an example, shown in Table 1, consider an applicant for a driver's license who begins the process on Feb. 18, 2010, passes the written and road tests, and is mailed a driver's license on Mar. 16, 2010:

TABLE 1

| Event # | Event description | Start Date | End Date |
|---|---|---|---|
| 1 | Applicant schedules written test | Feb. 18, 2010 | Feb. 18, 2010 |
| 2 | Applicant takes written test | Mar. 02, 2010 | Mar. 02, 2010 |
| 3 | DMV reviews written test | Mar. 02, 2010 | Mar. 04, 2010 |
| 4 | Applicant schedules road test | Mar. 04, 2010 | Mar. 04, 2010 |
| 5 | Applicant takes road test | Mar. 12, 2010 | Mar. 12, 2010 |
| 6 | DMV reviews road test | Mar. 12, 2010 | Mar. 12, 2010 |
| 7 | Driver's license is printed | Mar. 13, 2010 | Mar. 15, 2010 |
| 8 | Driver's license is mailed to | Mar. 16, 2010 | Mar. 16, 2010 |
| | applicant | | |

This process may also be illustrated in a flow chart, as shown in FIG. 1, in which process steps 101-108 correspond to Event #1-8, respectively.

For a process such as this driver's license application process, it may be helpful to be able to forecast certain event dates. For example, if another applicant submits a written test on Mar. 22, 2010, it may be helpful to be able to forecast the start or end date of a particular event, such as the road test (assuming that the applicant had passed the written test), which in this example is Event #5, or the department of motor vehicles mailing a driver's license (assuming that the applicant had passed the road test), which in this example is Event #8. This invention deals with such event forecasts.

Certain relatively limited methods are known in the art to provide some assistance in estimating when certain events may occur. For example, U.S. Pat. No. 7,783,562 discloses a method for obtaining an estimated financial outcome—a gain or a loss—for a particular loan. One element of that method is a method for obtaining an estimated liquidation time—an elapsed time from a last interest-paid date to the receipt of the liquidation proceeds received from the sale of the property—using a decision tree and various set time factors.

In another example, U.S. Patent Application Publication No. 2004/0019516 discloses a method for calculating the probability that one or more automobiles will be sold by a future date. This method uses survival analysis—a well-known statistical methodology—based on historical data for the number of days that an automobile remains on a sales lot to estimate a probability that one or more automobiles will be sold by a future date.

Among other limitations, these known methods are static; they assume that a process model (such as the process for liquidations or automobile sales) is stable over time. It would be advantageous to provide systems and methods that are dynamic: that can forecast events where the underlying duration distributions change over time.

### SUMMARY OF THE INVENTION

In one embodiment of the invention, a data processing method for forecasting event dates is provided. The method includes the steps of identifying a plurality of defined process events, and estimating dynamically for at least one event a duration distribution between a starting date of the event and an end date of the process. The estimated duration distribution is used for generating one or more modeling parameters used for generating one or more forecasts.

In another embodiment, the method includes the steps of identifying a plurality of defined process events, and estimating dynamically for one event a duration distribution between a first date of the one event and a second date of another event.

In another embodiment, the first date is a starting date of the one event, and the second date is an end date of the last event of the process.

In another embodiment, the one event is the same as the other event.

In another embodiment, the method further includes computing for the one event a time elapsed from the first date to a current date.

In another embodiment, the method further includes determining, based on the time elapsed, a conditional duration distribution from the first date to the second date.

In another embodiment, the method further includes selecting a measure of distributional center of the conditional duration distribution.

In another embodiment, the selected measure of distributional center is a median, a mean, a trimmed mean, or a quantile reasonably close to the mean.

In another embodiment, the method further includes associating with at least one of the one or more forecasts an uncertainty measure of the conditional distribution.

In another embodiment, the uncertainty measure is an inter-quartile range, a standard deviation, a mean absolute deviation from the selected measure of distributional center, or a range.

In another embodiment, a data processing system for forecasting event dates is provided. The system includes a memory device, and a processor device operatively connected to the memory device and configured to perform a method. The method includes the steps of identifying a plurality of defined process events, and estimating dynamically for at least one event a duration distribution between a starting date of the event and an end date of the process. The estimated duration distribution is used for generating one or more modeling parameters used for generating one or more forecasts.

In another embodiment, the method that the memory device is configured to perform further includes identifying a plurality of defined process events, and estimating dynamically for one event a duration distribution between a first date of the one event and a second date of another event.

In another embodiment, the system further includes means for computing for the one event a time elapsed from the first date to a current date.

In another embodiment, the system further includes means for determining, based on the time elapsed, a conditional duration distribution from the first date to the second date.

In another embodiment, the system further includes means for selecting a measure of distributional center of the conditional duration distribution.

In another embodiment, the system further includes means for associating with at least one of the one or more forecasts an uncertainty measure of the conditional distribution.

In another embodiment, a computer program product for forecasting event dates is provided. The computer program product includes a computer readable storage medium that is embodied with computer readable program code. The computer readable program code includes computer readable program code configured to identify a plurality of defined process events, and estimate dynamically for at least one event a duration distribution between a starting date of the event and an end date of the process. The estimated duration distribution is used for generating one or more modeling parameters used for generating one or more forecasts.

In another embodiment, the computer readable program code includes computer readable program code configured to identify a plurality of defined process events, and estimate dynamically for one event a duration distribution between a first date of the one event and a second date of another event.

### BRIEF DESCRIPTION OF THE DRAWINGS

FIG. 1 is a flow diagram depicting the events in a process for issuing a driver's license.

FIGS. 2A-2E are flow diagrams depicting multiple scenarios for the events in a process for mortgage origination.

FIG. 3A is a schematic illustration of processing by a system or method according to the invention for generating model parameters.

FIG. 3B is a schematic illustration of processing by a system or method according to the invention for generating forecasts based on the model parameters generated in FIG. 3A.

FIG. 4 is a functional plot showing an example of a step weighting function that may be used in accordance with the invention.

FIG. 5 is a functional plot showing an example of a triangular weighting function that may be used in accordance with the invention.

FIG. 6 is a functional plot showing an example of a kernel weighting function that may be used in accordance with the invention.

FIG. 7 is a block diagram of an exemplary hardware configuration in which the invention may be embodied.

FIG. 8 is a distribution plot illustrating an aspect of an example of forecasting in accordance with the invention.

FIG. 9 is a distribution plot illustrating another aspect of an example of forecasting in accordance with the invention.

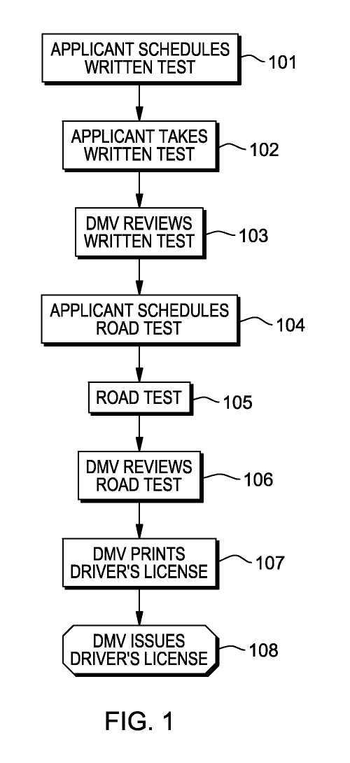

### DETAILED DESCRIPTION OF THE PREFERRED EMBODIMENTS

The systems and methods herein described accomplish event date forecasting for a process using dynamic estimation of a statistical model of the process based on historical data of the event dates for some or all of the events. Preferably, a forecast conditions on the forecast issue date (a “current date”) and yields a measure of center for the conditional distribution of the forecasted duration between forecast issue date and the target event date. Typically, the forecasted target event date will be the date of the end event in a process, but any target event in a process may be treated as the end event, as thus any event date may be the forecasted date.

The dynamic estimation according to these systems and methods adjust for temporal dynamics (such as shifts and other changes in historical-data distributions concerning a process). In addition, such systems and methods can adjust and improve the estimation using open cases (i.e., instances of a process still in progress), and delays (such as holds and moratoria in a process).

In one embodiment, a data processing method for forecasting event dates for a process having a plurality of process steps includes:
estimating dynamically for each process step or event the duration distribution between a starting date of the process step and an end date of the process;
computing for each unit at a particular step of the process the time elapsed in a current step by subtracting the starting date of the step from the current date (“today”);
determining, given the time elapsed, the conditional duration distribution from the starting date of the step (StepStartDate) to the end date of the process (ProcessEndDate);
selecting a measure of distributional center from a plurality of measures of distributional center of the conditional distribution; and
associating with the forecast an uncertainty measure from a plurality of variability measures of the conditional distribution.

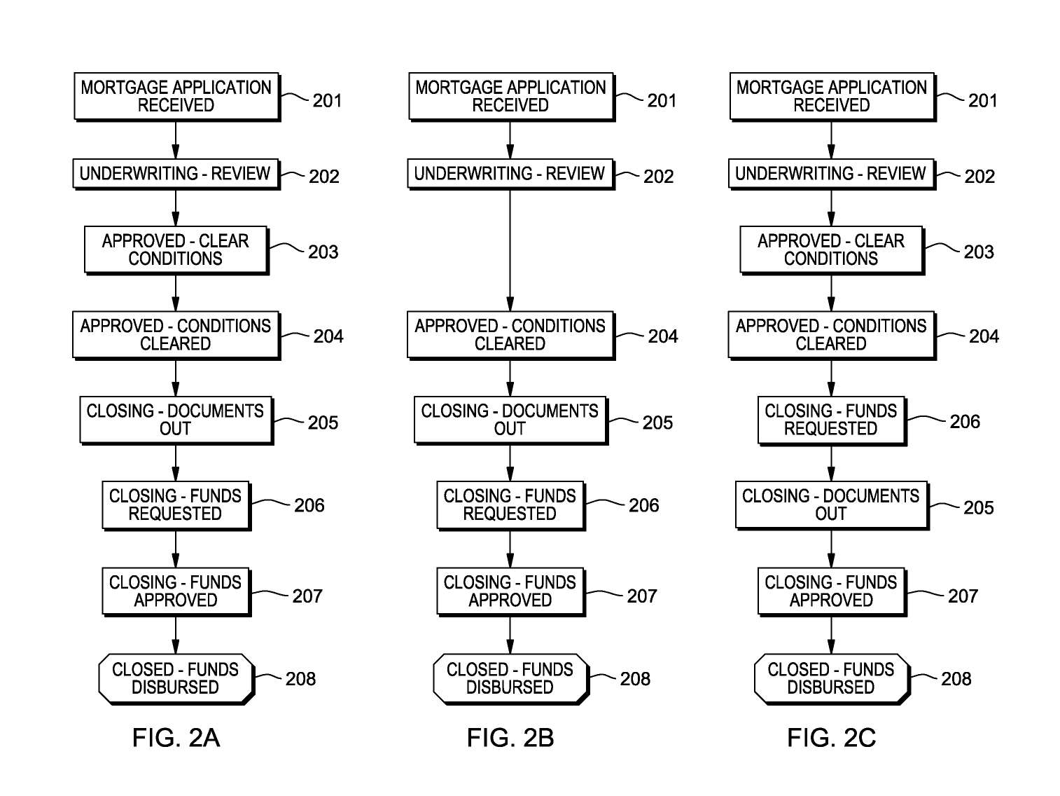

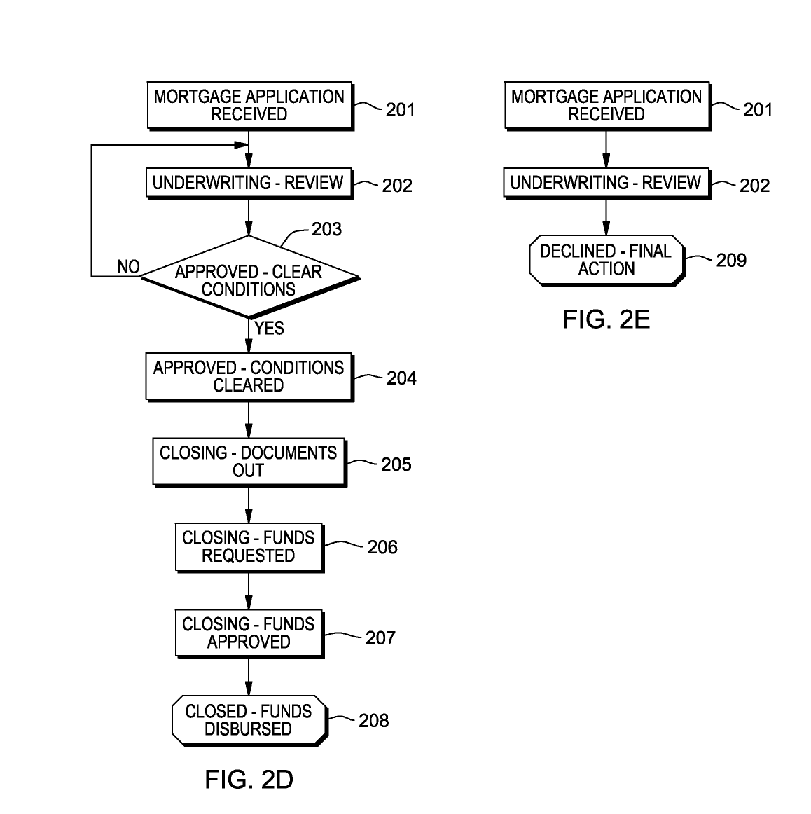

This embodiment may be illustrated using a mortgage origination process. As shown in FIG. 2A, the process includes eight process steps 201-208, corresponding to Event #1-8, respectively, as shown in Table 2:

TABLE 2

| Event # | Event description |
|---|---|
| 1 | Mortgage Application Received |
| 2 | Underwriting-Review |
| 3 | Approved-Clear Conditions |
| 4 | Approved-Conditions Cleared |
| 5 | Closing-Documents Out |
| 6 | Closing-Funds Requested |
| 7 | Closing-Funds Approved |
| 8 | Closed-Funds Distributed |

As shown in FIGS. 2B-E, the systems and methods can address multiple scenarios for the mortgage origination process illustrated in FIG. 2A, including a process step that is left out (FIG. 2B, which excludes step 203), process steps in a different order (FIG. 2C, in which steps 205 and 206 are reversed), process loops (FIG. 2D, in which the process loops for one or more iterations from step 203 to step 202 until step 203 is fully completed), and processes that terminate before the final possible process step (FIG. 2E, in which an additional event, step 209, occurs when the mortgage application is denied after Underwriting—Review in step 202).

Historical event data preferably consists of start and completion dates (alternatively called “end dates” or “stop dates”) for events in a process for a number of instances of the process. In the example of the mortgage origination process, each instance of the process is a particular mortgage or loan application, which can be identified by a loan number. A particular loan that has completed all events in the process is referred to as a closed case, one example of which is shown in Table 3. A particular loan that is still in process is referred to as an open case, one example of which is shown in Table 4.

TABLE 3

| Loan | Event | | | |
|---|---|---|---|---|
| # | # | Event description | Start Date | Stop Date |
| 3224 | 1 | Mortgage Application | Mar. 01, 2010 | Mar. 01, 2010 |
| | | Received | | |
| 3224 | 2 | Underwriting-Review | Mar. 02, 2010 | Mar. 21, 2010 |
| 3224 | 3 | Approved-Clear | Mar. 22, 2010 | Mar. 28, 2010 |
| | | Conditions | | |
| 3224 | 4 | Approved-Conditions | Mar. 29, 2010 | Mar. 29, 2010 |
| | | Cleared | | |
| 3224 | 5 | Closing-Documents Out | Mar. 30, 2010 | Apr. 07, 2010 |
| 3224 | 6 | Closing-Funds Requested | Apr. 10, 2010 | Apr. 10, 2010 |
| 3224 | 7 | Closing-Funds Approved | Apr. 22, 2010 | Apr. 24, 2010 |
| 3224 | 8 | Closed-Funds Distributed | May 02, 2010 | May 02, 2010 |

TABLE 4

| Loan | Event | | | |
|---|---|---|---|---|
| # | # | Event description | Start Date | Stop Date |
| 3225 | 1 | Mortgage Application | Mar. 02, 2010 | Mar. 02, 2010 |
| | | Received | | |
| 3225 | 2 | Underwriting-Review | Mar. 03, 2010 | Mar. 24, 2010 |
| 3225 | 3 | Approved-Clear | Mar. 29, 2010 | Apr. 02, 2010 |
| | | Conditions | | |
| 3225 | 4 | Approved-Conditions | Apr. 03, 2010 | Apr. 03, 2010 |
| | | Cleared | | |
| 3225 | 5 | Closing-Documents Out | Apr. 04, 2010 | |
| 3225 | 6 | Closing-Funds Requested | | |
| 3225 | 7 | Closing-Funds Approved | | |
| 3225 | 8 | Closed-Funds Distributed | | |

In the examples of Tables 3 and 4, the last two columns are labeled “Start Date” and “Stop Date” because it is possible that an event may begin on a first date and end on a second date. For example, Event #2 (Underwriting—Review) begins for Loan #3224 on Mar. 2, 2010 and ends on Mar. 21, 2010, and for Loan #3225 begins on Mar. 3, 2010 and ends on Mar. 24, 2010.

Whether loan data represents an open case or a closed case depends on the target date for a forecast. For example, in Table 4, if the target date is the stop date of the last step of the process, then the absence of a stop date for Event #8 indicates that Loan #3225 is an open case of the mortgage origination process. In another example, if the target date is the start date of Event #5, then the presence of a start date for that event indicates that Loan #3225 is a closed case.

Preferably, the systems and methods forecast the time from the starting date of an event or process step (StepStartDate) to the end date of the last event or step in the process (ProcessEndDate). But the systems and methods may also be used to forecast the time from the start or end date of any event to the start or end date of any later event, or from the start date of an event to the end date of that event.

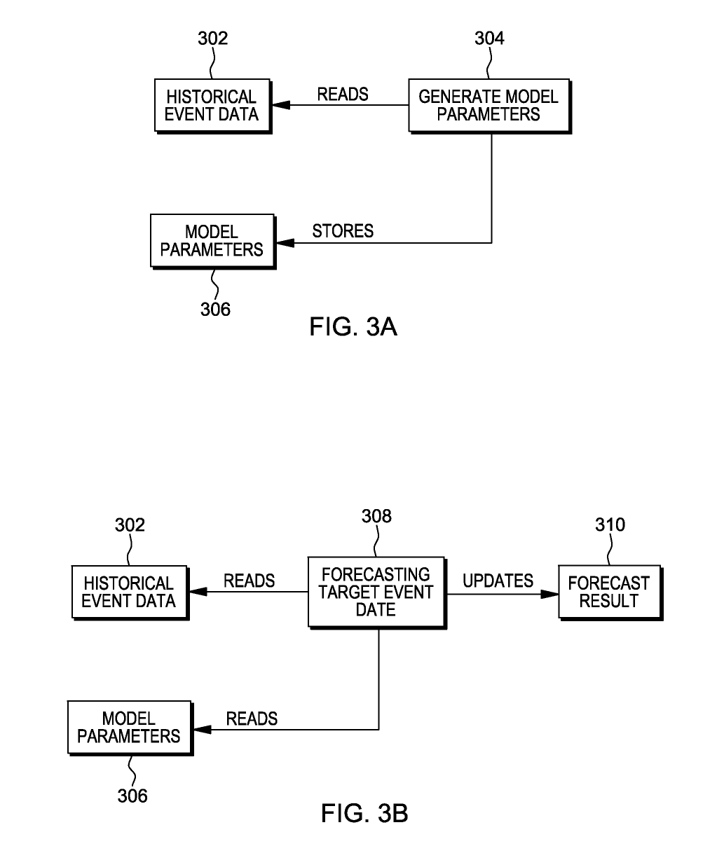

FIG. 3A illustrates processing by an aspect of a system or method for generating model parameters. At block 304, model parameters are generated after reading historical event data, at block 302, and then the model parameters are stored at block 306. Dynamic estimation of the model parameters using event historical data is preferably carried out when generating the model parameters at block 304.

FIG. 3B illustrates processing by an aspect of a system or method for forecasting target event dates based on the generated model parameters. At block 308, forecasting a target event date is accomplished after reading historical event data, at block 302, and reading estimated model parameters, at block 306. The forecast is then output, at block 310.

It may be desirable to have the generation of model parameters in FIG. 3A and the generation of one or more forecasts in FIG. 3B take place at different intervals. For example, generating model parameters weekly and generating one or more forecasts daily or as needed.

Data for loans such as Loan #3224—in which the target event has been completed—are preferably stored in a Steps Closed Table with the following columns:
Loan #—a number that uniquely identifies each mortgage application
Event Description—a unique description of each event or step
Start Date—event start date (which may have a null or other value to indicate no date)
Stop Date—event stop date (which may have a null or other value to indicate no date, which may be the same as the Start Date)
Duration 1—duration from event Start Date to a target Stop Date
Duration 2—Duration 1 minus any hold time

Data for loans such as Loan #3225—in which the target event has not yet been reached—are preferably stored in a Steps Open Table with the following columns:
Loan #—a number that uniquely identifies each mortgage application
Event Description—unique description of each event or step
Start Date—event start date (which may have a null or other value to indicate no date)
Stop Date—event stop date (which may have a null or other value to indicate no date, or which may be the same as the Start Date)
Current Step—a flag to indicate the current step of the process
Duration 3—duration from event Start Date to “today”
Duration 4—Duration 3 minus any hold time

In the Steps Open Table, “today” is the day that the forecast is considered made, which may also be referred to as a “current date.” It may be the actual date when a system or method is used to make a forecast, or a date when the forecast is considered to be made.

Data concerning holds in the process that have been completed are preferably stored in a Holds Closed Table with the following columns:
Loan #—a number that uniquely identifies each mortgage application
Hold Description—a unique description of each hold
Start Date—hold start date
Stop Date—hold stop date (which may be the same as the Start Date)
Duration 5—duration from hold Start Date to hold Stop Date

Data concerning holds in the process that have not been completed are preferably stored in a Holds Open Table with the following columns:
Loan #—a number that uniquely identifies each mortgage application
Hold Description—a unique description of each hold
Start Date—hold start date
Duration 6—duration from hold Start Date to “today”

Again, in the Holds Open Table, “today” is the day that the forecast is considered made.

As an example of a forecast made using a system or method, say that on Apr. 19, 2010 a forecast is desired for completing the mortgage application process for Loan #3225. As shown in Table 4, as of that date the loan is currently in Event #5 because Loan #3225 has started but not yet completed Event #5. A system or method therefore preferably generates model parameters based on a duration distribution from the Start Date of Event #5 to the end of the mortgage application process (in this case the Stop Date of Event #8).

The step of dynamically estimating for each process event the duration distribution between the starting date of the process step and the end date of the process (or other target date) preferably includes defining a series of time points {t₁, t₂, . . . t_{T}} and a series of data weighting functions {w₁, w₂, . . . w_{T}}. The data weighting functions may or may not depend on the data availability.

For example, a series of time points based on calendar quarters could consist of the last date of each quarter (T=4 and t₁=March 31, t₂=June 30, t₃=September 30, and t₄=December 31) or an approximate midpoint of each quarter (e.g., T=4 and t₁=February 15, t₂=May 15, t₃=August 15, and t₄=November 15). Many other series of time points may be used based on various intervals (e.g., daily, weekly, monthly, quarterly, yearly, etc.) and various points within those intervals (e.g., first date of each week, first date of second week each month, midpoint, last Thursday of each quarter, last date of each week, etc.). Preferably the time points are at regular intervals (e.g., quarterly), but irregular or random intervals may also be used (e.g., T=5 and t₁=March 31, t₂=June 15, t₃=September 1, t₄=November 15, and t₅=December 24).

The duration may be measured in any suitable time unit. For example, in addition to the intervals mentioned above, shorter durations (e.g., hours, minutes, seconds, etc.) or longer durations (e.g., weeks, months, years, decades, centuries, millennia) may be used. Any forecast made using, and any date used by, systems and methods described herein—including start dates, stop dates, and current dates—may be expressed in any degree of duration (e.g., March 15; Mar. 15, 2010; or Mar. 15, 2010 at 4:15:3.5 pm, meaning 4:15 plus 3.5 seconds on the afternoon of Mar. 15, 2010).

Weighting functions may be of varying types known to those skilled in the art (e.g., step functions, piecewise linear functions, kernels).

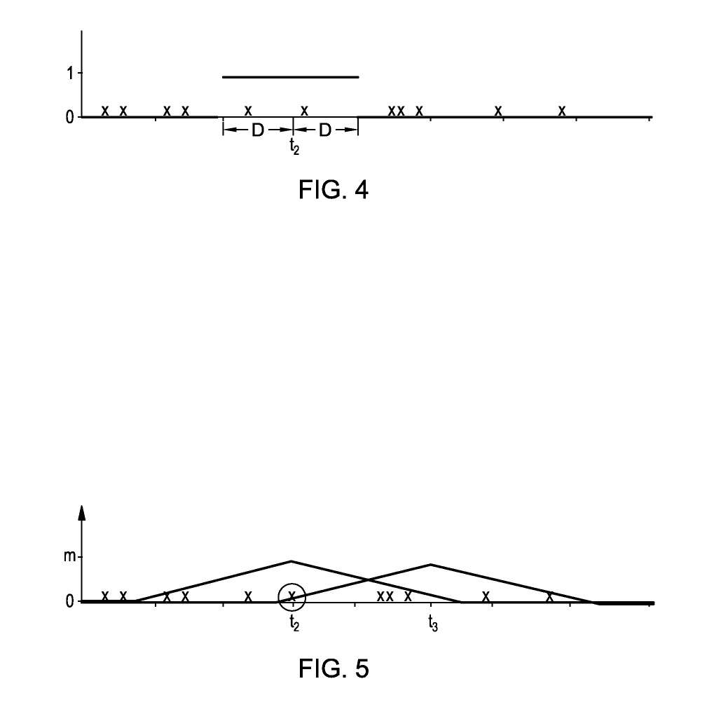

For example, as shown in FIG. 4, a step weighting function may be used. FIG. 4 depicts for the Start Date of Event #5 a weighting function w₂ for a time t₂. In the plot of FIG. 4, the x-axis shows time in days, with each “×” indicating the occurrence of the event start date for a particular loan, and the y-axis shows the assigned weight. An interval or time window D is defined on either side of a time t₂ (e.g, D=45 days), and the weight is assigned according to these equations:

w₂=1 if t₂ε[t₂−D, t₂+D)

w₂=0 otherwise

As skilled artisans will recognize, in order to accurately estimate the duration distributions a certain number of events L for each time point may be needed. In such a case, “data dependent” time windows may be used. For example, if time t₂ has less than L events in the interval [t₂−D , t₂+D), the time window may be increased for that time point by increasing D so that the time window covers at least L events.

Another type of weighting function that may be used is a triangular (piecewise linear) function, which may or may not overlap for different time points. When weighting functions overlap, the same event can be used for different duration distributions. For example, FIG. 5 shows for the Start Date of Event #5 overlapping triangular weighting functions for times t₂ and t₃. In this example, the circled event start date occurrence is used for estimating the duration distributions for both times t₂ and time t₃. This event has a very high weight for the duration distribution estimated for t₂ (the value of the left-most triangle is almost full weight m for the circled event occurrence), but it has a very small weight for the duration distribution estimated for t₃ (the value of the right-most triangle is close to zero for the circled event occurrence).

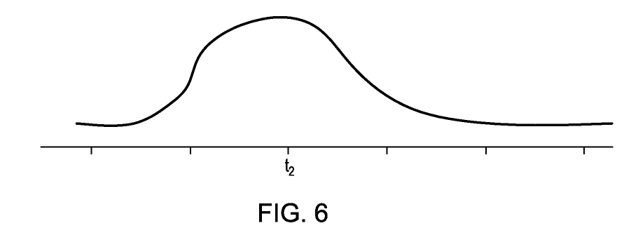

Another type of weighting function that may be used is a kernel. For example, FIG. 6 shows for the Start Date of Event #5 a kernel weighting function based on the normal (“bell-shaped”) distribution. As skilled artisans will recognize, the kernel may be based on distributions other than the normal distribution.

Those of skill in the art will also recognize that the same weighting function may be used for each point in the time series (e.g., if T=4, for t₁, t₂, t₃ and t₄ the weighting functions w₁, w₂, w₃ and w₄ will be the same, but centered at t₁, t₂, t₃ and t₄, respectively), or different weighting functions—or no weighting at all—may be used for some or all of the points in the time series.

Dynamic estimation further includes modeling distributional changes over time using the previously defined series of time points and weighting functions, preferably by either:
(1) estimating a series of a suitable parametric models (e.g., a Weibull distribution) and tracking the estimated model parameters (e.g. the estimated parameters of the Weibull distribution) over time (possibly using weighted data); or
(2) modeling distributional changes over time non-parametrically, for instance by:
   (a) tracking historical measures of center and variability for the time periods;
   (b) standardizing the data in the time periods by using measures of center and variability; and
   (c) estimating the “characteristic distribution” after combining the standardized data for multiple periods (the characteristic distribution can be estimated parametrically or non- parametrically, e.g., using an empirical histogram).

Other methods (parametric, non-parametric, semi-parametric, etc.) of modeling distributional changes over time can also be used.

The distributions can be estimated based on complete observations only (based on data in the Steps Closed table), or using an adjustment for censoring (such as the Kaplan-Meier adjustment) to make use of both the complete incomplete observations (i.e. the data in both the Steps Closed and Steps Open table).

Additionally, the distribution can be estimated using the “raw” StepStartDate-to-ProcessEndDate durations or after removing internal and/or external delays (holds, moratoria, other delays).

The step of computing the dynamic distribution for time period p (where p is, e.g., a time period covering a time point of interest tᵢ or the current time period) may be done, in the parametric case, using the observed or forecasted parametric model parameters for time period p (or time point tᵢ), or in the non-parametric case, by reversing the standardization (i.e., using observed or forecasted measures of center and variability for time period p to transform the characteristic distribution into an untransfonned estimated distribution for time period p.)

The step of determining, given the time elapsed, the conditional duration distribution from the starting date of the step (StepStartDate) to the end date of the process (ProcessEndDate) preferably includes, in the parametric case, deriving the conditional distribution analytically by conditioning it on the duration being larger than the time elapsed; or, in the non-parametric case, truncating the histogram to time periods that are larger than the time elapsed.

The step of selecting a measure of distributional center preferably includes specifying the center of the conditional distribution as the median, mean, trimmed mean, any other quantile reasonably close to the mean, or other measure of distributional center.

The step of associating an uncertainty (variability) measure with the forecast preferably includes using the inter-quartile range, standard deviation, mean absolute deviation from a measure of center, range, or other measure of variability.

The number and types of processes for which event forecasting may be accomplished using the systems and methods described herein are practically unlimited. In addition to the examples discussed previously, other examples of such processes are immigration permissions (e.g., issuing a Green card), warranty or insurance claim payouts, publication of an academic journal article, the issuance of a state license to operate a certain type of business and a process termination date in any supply chain scenario that requires a sequence of steps.

As an example of forecasting in accordance with the systems and methods described herein, consider a forecast made on Apr. 19, 2010 of the completion of the last event in the mortgage origination process for Loan #3225 in Table 4. The target date to be forecast is the stop date of Event #8. From Table 4 it may be seen that the current step date is the start date of Event #5, which is Apr. 4, 2010. The current date or “today” is Apr. 19, 2010.

Of the 15 possible sets of model parameters for the end of the process—one set of parameters for each of the durations to the stop date of Event #8 from the start and stop dates of Events #1-7 and the start date of Event #8—the model parameters are generated for the duration from start date of Event #5 to the end date of Event #8. Using all the historical event data from the Steps Closed Table and the Steps Open Table, the model parameters are generated using dynamic estimation as described above that may adjust for temporal dynamics, open cases, and delays.

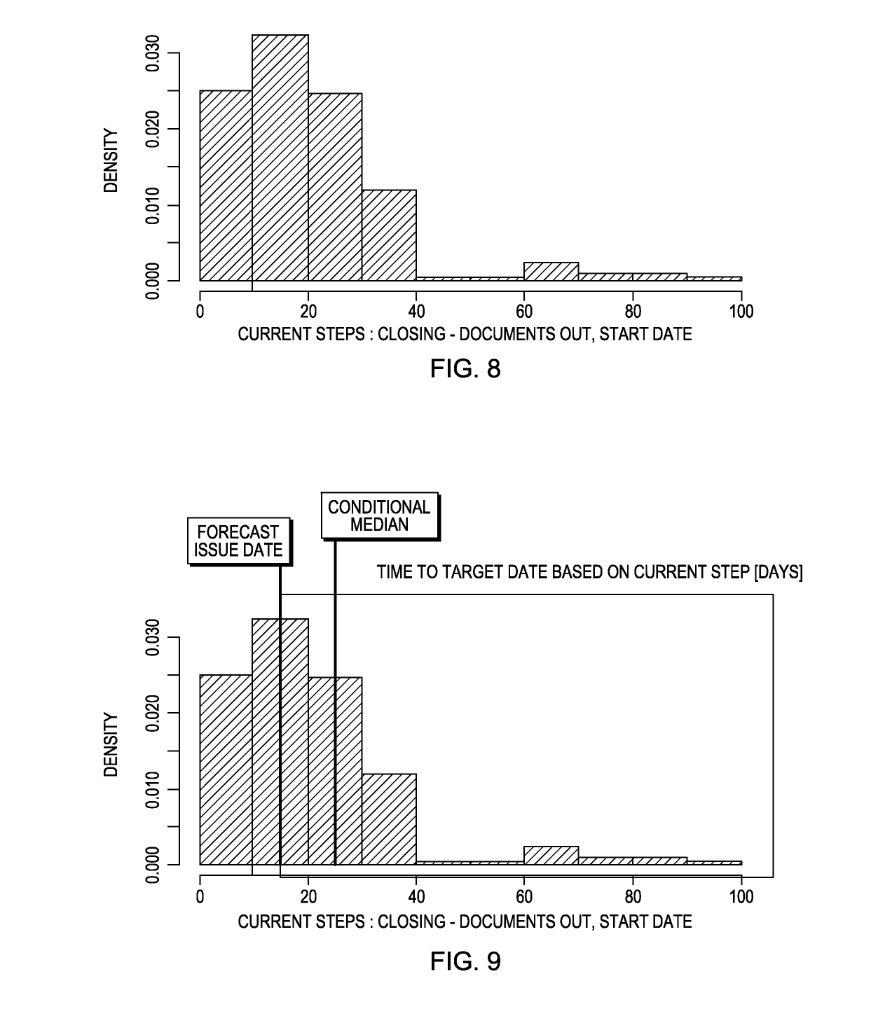

FIG. 8 is a distribution plot of an example of model parameters generated for the duration from the start date of Event #5 to the target date. For this example, consider the case in which a conditional median is used as the measure of distributional center of the conditional duration distribution. As shown in FIG. 9, the conditional median is determined forward from day 15 (i.e., the duration from the current step date, Apr. 4, 2010, to today, Apr. 19, 2010). In the example of FIG. 9, the conditional median is 26 days. That duration is added to the current step date, Apr. 4. 2010, to calculate the forecast date of Apr. 30, 2010. In other words, in this example, it is forecast that the mortgage origination process for Loan #3225 will be complete on Apr. 30, 2010.

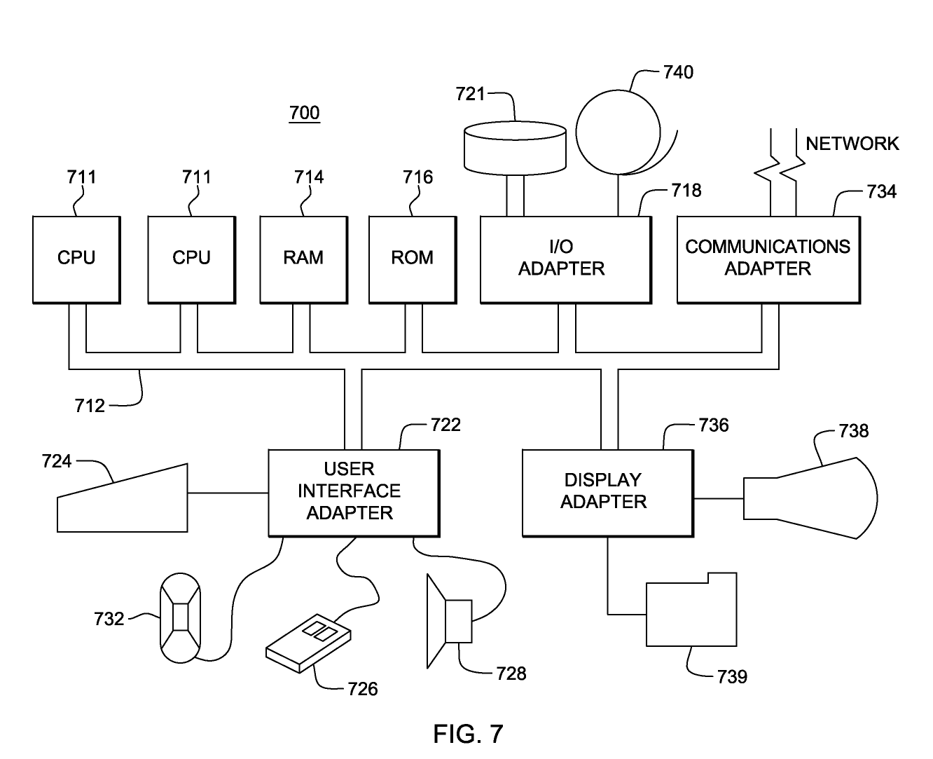

FIG. 7 illustrates an exemplary hardware configuration of a computing system 700 configured to perform the method steps such as shown and described in FIGS. 3A and 3B. The hardware configuration preferably has at least one processor or central processing unit (CPU) 711. The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting the system 700 to a data processing network, the Internet, an Intranet, a local area network (LAN), etc., and a display adapter 736 for connecting the bus 712 to a display device 738 and/or printer 739 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to illustrations and/or block diagrams of methods, apparatus (systems) and computer program products according to embodiments of the invention. It will be understood that each block of the illustrations and/or block diagrams, and combinations of blocks in the illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the block diagram block or blocks.

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or illustration, and combinations of blocks in the block diagrams and/or illustration, can be implemented by special purpose hardware-based systems that perform the specified functions or acts, or combinations of special purpose hardware and computer instructions.

1. A data processing method for forecasting event dates, the method comprising the steps of:
(a) identifying a plurality of defined process events; and
(b) estimating dynamically for at least one event a duration distribution between a starting date of the event and an end date of the process, wherein the estimated duration distribution is used for generating one or more modeling parameters used for generating one or more forecasts.

2. A data processing method for forecasting event dates, the method comprising the steps of:
(a) identifying a plurality of defined process events; and
(b) estimating dynamically for one event a duration distribution between a first date of the one event and a second date of another event, wherein the estimated duration distribution is used for generating one or more modeling parameters used for generating one or more forecasts.

3. The data processing method of claim 2, wherein the first date is a starting date of the one event, and the second date is an end date of the last event of the process.

4. The data processing method of claim 2, wherein the one event is the same as the other event.

5. The data processing method of claim 2, further comprising computing for the one event a time elapsed from the first date to a current date.

6. The data processing method of claim 5, further comprising determining, based on the time elapsed, a conditional duration distribution from the first date to the second date.

7. The data processing method of claim 6, further comprising selecting a measure of distributional center of the conditional duration distribution.

8. The data processing method of claim 7, wherein the selected measure of distributional center is a median, a mean, a trimmed mean, or a quantile reasonably close to the mean.

9. The data processing method of claim 7, further comprising associating with at least one of the one or more forecasts an uncertainty measure of the conditional distribution.

10. The data processing method of claim 9, wherein the uncertainty measure is an inter-quartile range, a standard deviation, a mean absolute deviation from the selected measure of distributional center, or a range.

11. A data processing system for forecasting event dates, the system comprising:
(a) a memory device;
(b) a processor device operatively connected to the memory device and configured to perform a method, the method comprising the steps of:
(i) identifying a plurality of defined process events; and
(ii) estimating dynamically for at least one event a duration distribution between a starting date of the event and an end date of the process, wherein the estimated duration distribution is used for generating one or more modeling parameters used for generating one or more forecasts.

12. A data processing system for forecasting event dates, the system comprising:
(a) a memory device;
(b) a processor device operatively connected to the memory device and configured to perform a method, the method comprising the steps of:
(i) identifying a plurality of defined process events; and
(ii) estimating dynamically for one event a duration distribution between a first date of the one event and a second date of another event, wherein the estimated duration distribution is used for generating one or more modeling parameters used for generating one or more forecasts.

13. The data processing system of claim 12, wherein the first date is a starting date of the one event, and the second date is an end date of the last event of the process.

14. The data processing system of claim 12, wherein the one event is the same as the other event.

15. The data processing system of claim 12, the method further comprising computing for the one event a time elapsed from the first date to a current date.

16. The data processing system of claim 15, the method further comprising determining, based on the time elapsed, a conditional duration distribution from the first date to the second date.

17. The data processing system of claim 16, the method further comprising selecting a measure of distributional center of the conditional duration distribution.

18. The data processing system of claim 17, wherein the selected measure of distributional center is a median, a mean, a trimmed mean, or a quantile reasonably close to the mean.

19. The data processing system of claim 17, the method further comprising associating with at least one of the one or more forecasts an uncertainty measure of the conditional distribution.

20. The data processing system of claim 19, wherein the uncertainty measure is an inter-quartile range, a standard deviation, a mean absolute deviation from the selected measure of distributional center, or a range.

21. A computer program product for forecasting event dates, the computer program product comprising:
a computer readable storage medium having computer readable program code embodied therewith, the computer readable program code comprising:
(a) computer readable program code configured to identify a plurality of defined process events; and
(b) computer readable program code configured to estimate dynamically for at least one event a duration distribution between a starting date of the event and an end date of the process, wherein the estimated duration distribution is used for generating one or more modeling parameters used for generating one or more forecasts.

22. A computer program product for forecasting event dates, the computer program product comprising:
a computer readable storage medium having computer readable program code embodied therewith, the computer readable program code comprising:
(a) computer readable program code configured to identify a plurality of defined process events; and
(b) computer readable program code configured to estimate dynamically for one event a duration distribution between a first date of the one event and a second date of another event, wherein the estimated duration distribution is used for generating one or more modeling parameters used for generating one or more forecasts.

23. The computer program product of claim 22, wherein the first date is a starting date of the one event, and the second date is an end date of the last event of the process.

24. The computer program product of claim 22, wherein the one event is the same as the other event.

25. The computer program product of claim 22, the computer readable program code further comprising computer readable program code configured to compute for the one event a time elapsed from the first date to a current date.
